(19) United States
(12) Patent Application Publication
(10) Pub. No.: US 2007/0124185 A1
(43) Pub. Date: May 31, 2007

(54) STATE ENGINE FOR BUSINESS PROCESS EXECUTION

(75) Inventors: Alex Elkin, Littleton, MA (US); Scott Opitz, Media, PA (US)

Correspondence Address: BLANK ROME LLP, ONE LOGAN SQUARE, PHILADELPHIA, PA, 19103, US

(73) Assignee: LOGIC EXPLORERS INC., Media, PA (US)

(21) Appl. No.: 11/164,619

(22) Filed: Nov. 30, 2005

(51) Int. Cl. G06F 9/46

(52) U.S. Cl. 705/8

(57) ABSTRACT

A method and system are described for maintaining the states of the instances of business processes. The method and the system use the definitions of the business processes to interpret the messages from the business activities, associate the messages with the expected and unexpected business activities in the known and unknown instances of the business processes.

### BACKGROUND

Any enterprise executes a number of business processes whether explicitly or implicitly defined. A business process consists of business activities and the transitions between them. For example, a retail store may have business processes “Process Customer Order”, “Get Inventory from Suppliers”, “Process Monthly Payroll” and so on. The process “Process Customer Order” may include the activities “Display Catalog”, “Review Shopping Cart”, “Submit Order”, “Account Verification”, “Inventory Check”, “Ship Order”, etc.

In many cases the individual activities or groups of activities are implemented as separate computer systems or applications. The applications interact with each other through the variety of interfaces, for example, event brokers, Web Services and API calls.

Any process may have a number of process instances. For example, “Process Customer Order” will have a separate instance for every customer order being processed at any given time. If the processing of an order from its receipt to its shipment takes several days or even weeks, the number of process instances can be very large.

All process instances have State. The state determines where the instance is in its execution. In most cases the state means the business activity that is currently under execution for the specific instance. For example, the current state of the “Process Customer Order” process instance for order #123456 is in “Order Shipping”. The process state may also include the values of some set of parameters, relevant for all elements of the process. For example, a process may have “Start Date/Time”, “Order Number”, and “Order Total Value” as parameters whose values should be a part of the process state.

Many applications require the knowledge of the current state for every instance of their business processes. Examples of these type of applications include Business Process Management, Business Activity Monitoring, Business Performance Management and Process Simulations. The traditional approach to state maintenance is:
(1) Receive a completion event or progress report from a business activity;
(2) Identify the process instance to which the activity belongs;
(3) Make a record of the process instance that has completed the activity;

The task of identifying a specific process instance from the large pool of instances has existed since computer systems were first implemented in enterprises. Traditionally, two approaches were used for this purpose.

In the first approach, a unique process identifier (PID) is created when the process starts. All activities of the process are expected to carry this PID. For example, an online retail store may use an Order Number; an airline may use a Ticket Confirmation Code. This is precisely why when a person calls customer service of the store or airline, an agent asks for some form of the PID.

This approach is mostly used by systems implemented end-to-end using Business Process Automation (BPA) technology. The PID is sent to every business activity in the process and expected to be received when the activity reports its results. This approach does not produce the results when some of the business activities do not accept or return the PID. This problem causes the PID approach to be unusable in a large number of cases.

The second approach uses some combination of data available to an activity in order to locate the process instance. If a person tells the customer service agent that he does not know the confirmation code, the agent asks for some other data: name, date of the flight, departure airport.

In a similar fashion, when BPA systems are implemented with some activities that do not support PID, developers have to select the data suitable for identifying the process instance manually. This manual task has been performed again and again since the massive adoption of BPA in early 2000. The same approach is also described in the patent application Ser. No. 10/898,464.

The fundamental problem with this approach is that it requires the manual definition of the identifiable data in every activity of every business process in the enterprise. Moreover, software developers must maintain these definitions as the enterprise changes its business processes and activities. Another problem with this approach is that some activities may not provide sufficient identifiable data which can result in the system identifying more than one process instance to which activity could belong.

### DESCRIPTION OF THE PREFERRED EMBODIMENT

The present invention provides a system and a method, implemented on a computer system, for maintaining the current state of the instances of business processes.

The implementations set forth in the following description do not represent all possible implementations for the claimed invention. Other implementations can be used and structural and procedural changes may be made without departing from the scope of the present invention.

The present invention uses the definitions of the business processes to create a reliable, cost efficient and easy to maintain computer system that manages the current states of all business process instances. Consistent with the embodiments of the invention, the process definitions can be obtained from a plurality of sources such as automatic discovery as described in the patent application Ser. No. 11/163867, through an import procedure from other systems or applications, or they may be created by the users.

Consistent with the embodiments of the invention, the definitions of the business processes include or can be translated into the declarations of the properties of the processes, business activities that constitute the processes, descriptions of the messages that the business activities send and receive; data relationships between the properties of the processes, properties of the activities and the data fields of the messages.

Consistent with the embodiments of the invention, the process definitions are stored in the computer readable form accessible by the State Engine.

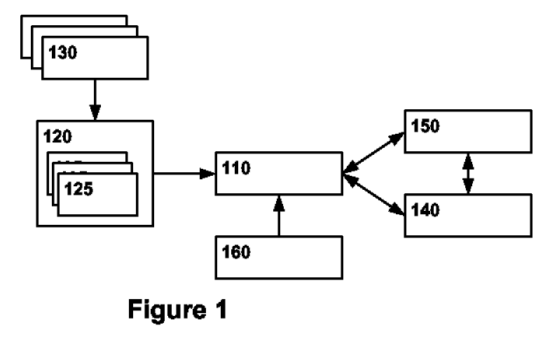

Consistent with the embodiments of the invention, the system is implemented as a computer program and is executed on one or more computers connected via the computer network as shown on FIG. 1. State Engine 110 utilizes some type of mass storage 140, typically a database, to provide the data persistence. To increase performance the State Engine may also use data stored in computer memory RAM 150. The data in RAM are saved to mass storage 140 so the system doesn't suffer the loss of data in case of system failures.

The State Engine has access to the definitions of the business processes 160. In the embodiments of the invention, the definitions of the business processes may be stored as database records, XML files, computer executable code or other forms. Consistent with the embodiments of the invention, the storage mechanism for the business process definitions 160 could be 140 and 150 or independent from them.

The State Engine receives the messages 120 from a plurality of computer systems and applications 130, capable of reporting the completion or progress of the business activities. The systems and applications 130 may include packaged applications such as ERP (Enterprise Resource Planning), CRM (Customer Relationships Management), Inventory Management, Sales; application and web servers; EAI (Enterprise Application Integration) systems, BPA (Business Process Automation) systems, BMP (Business Process Management) systems, etc.

The messages 120 include structured data related to business activities completion or the progress of the business activities. The term “structured” means the data in the message consists of or can be accessed as data fields 125. Consistent with the embodiments of the invention, one or more of the data fields of the message may represent the sender of the message; the same or another field may represent the business activity that initiated the sending of the message. This latter field is commonly referred to as the “Message Type” or “Message Name”. For the purposes of this description, we will use the term Message Type hereafter.

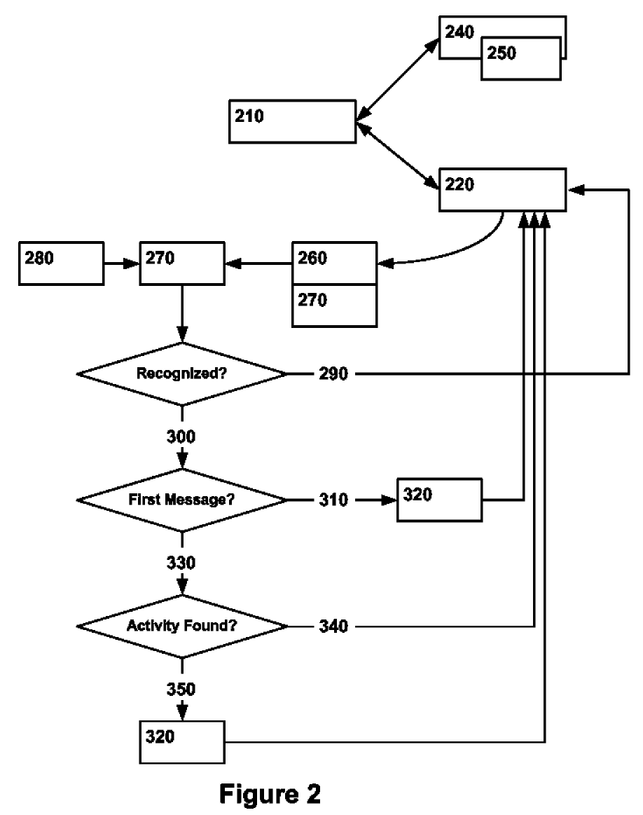

In one embodiment of the invention, the State Engine utilizes the method consisting if the following steps, shown on FIG. 2.
(1) At any time, the State Engine 210 “knows” the current states 220 of the business process instances. Each process instance is assigned a unique internal identifier PID. If the states of some instances are not known, see description of step 11.
(2) For every business process instance the State Engine determines the next business activity or activities 260 that this process instance is expected to execute. The State Engine makes this determination based on the definitions of the business processes 240 and the current state of this instance 220.
(3) The State Engine uses the data relationships 250, which are part of the process definition 240, to determine what data 270 should be expected when the next activity 260 reports its completion or progress.
(4) The combination of the expected next activities 260, the expected data 270 and process instance identifier PID is placed into the Waiting List 270.
(5) When a new message 280 arrives the State Engine searches for this message in the Waiting List 270 and compares the data fields of the message, including the Message Type, to those in the Waiting List 270.
(6) If the message 280 is recognized 290 the State Engine obtains the PID from the Waiting List 270, updates the process state related to this PID 220 so it reflects the activity and the data received in the message 280. The rules for updating the data in the process state are obtained from the definitions of the business processes 240 including the data rules 250.
(7) If the message 280 is not recognized 300, the State Engine checks the process definitions 240 to determine if this message type is the first message in any declared process.
(8) If the message 280 is a first message 310, the State Engine creates a new process instance by issuing a new PID and creating a new process instance state 320 and adding it to the known process states 220.
(9) If the message is not 330 the first message in a process definition, the State Engine uses the known states of the process instances 220 and data relationships 250 to transform the message data 280 to the expected data type of the business activity for the same Message Type as 280 for any instance of the process from 220.
(10) If the message data 280 can be transformed 340 the State Engine sets the business activity found in the previous step as the current state of the process instance in 220.
(11) If the message data can not be transformed 350 the State Engine creates a new process instance by issuing a new PID and creating a new process instance state 320 based on the Message Type and data fields of 280 and places it into the storage of known process states 220.

What is claimed is:

1. A method of maintaining the current state of the instances of the business processes, the method comprising:
Creating process state instances for every instance of a business processes;
Using the definitions of business processes to determine the expected next business activity for a given instance of the business process and the data received from this activity on completion or execution progress of this activity;
Maintaining a waiting list of expected results of the business activities and the unique identifiers of the current state of the business process instances;
Processing the messages from the business activities and updating the current state of the business process instances.

2. The method of claim 1, wherein creation of the process state instances for each business process instance is comprised of the associated business activity, the values of the properties of the business process instance and the unique identifier and providing the persistent storage for these elements.

3. The method of claim 1, wherein using the definitions of the business processes to determine the expected next business activity related to the given instance of the business process and the data received from this activity on completion or execution progress of this activity comprises determining at least one next expected business activity; using the data relationships from the process definition to determine a subset of the data expected to be received from the next business activity.

4. The method of claim 1, wherein maintaining the waiting list of the expected results from the business activities and the unique identifiers of the current state of the business process instances comprises adding and removing the waiting list entries consisting of a) the message type, corresponding to the business activity; b) data expected to be received from this business activity; c) unique identifier of the process state corresponding to the instance of the business process.

5. The method of claim 1, wherein processing the messages from the business activities and updating the current state of the business process instances comprises:
Accessing the message data as the set of data fields;
Finding the entry in the waiting list that corresponds to the message based on the message type and the message data;
Updating the process state that is the part of the found entry of the waiting list;
If the entry is the waiting list is not found, using the process definitions to create the process state for the new process instance or to update the state of the existing process instances.

6. The method of claim 5, wherein using the process definitions to create the process state for the new process instance or to update the state of the existing process instances comprises the method of determining if the message represents a new instance of a business process, or a unexpected state of an existing process instance or next step of an existing process instance but not known to the system.

7. The method of claim 6, wherein determining if the message represents unexpected state of an existing process instance comprises the transformation of the process states of the existing process instances by the data relationships of the process definitions to match the data of the message.

8. A computer system utilizing the method of claim 1 that maintains the states of the business processes.
